(19) United States
(12) Patent Application Publication
(10) Pub. No.: US 2014/0209584 A1
(43) Pub. Date: Jul. 31, 2014

(54) LASER MACHINING DEVICE

(71) Applicant: Hon Hai Precision Industry Co., Ltd., (US)

(72) Inventor: YUNG-CHANG TSENG, New Taipei (TW)

(73) Assignee: HON HAI PRECISION INDUSTRY CO., LTD., New Taipei (TW)

(21) Appl. No.: 13/848,733

(22) Filed: Mar. 22, 2013

(30) Foreign Application Priority Data
Jan. 25, 2013 (TW) 102102820

(51) Int. Cl. B23K 26/04

(52) U.S. Cl. CPC B23K 26/048
USPC 219/121.81

(57) ABSTRACT

A laser machining device includes a stationary platform configured for carrying a workpiece, a movable platform opposite to the stationary platform, a laser machining unit and a distance measuring unit both fixed on the movable platform. The laser machining unit machines micro-structures on the workpiece. The distance measuring unit measures a distance between the movable platform and the workpiece, and adjusts the movable platform to make sure a laser beam emitted by the laser machining unit is focused on the workpiece.

### BACKGROUND

1. Technical Field

The present disclosure relates to a laser machining device.

2. Description of Related Art

A die core including dot patterns used for manufacturing a light guide plate is usually made of metal such as a steel plate. The dot patterns on the die core are machined by a laser beam focused on a surface of the die core. Yet, the die core may be warped and the laser beam cannot be focused on the surface of the die core at the warped portion, which results in a change of the size of the dot patterns.

Therefore, it is desirable to provide a laser machining device which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a laser machining device according to an exemplary embodiment of the present disclosure, the laser machining device including a distance measuring unit.

FIG. 2 is a schematic view of the distance measuring unit of FIG. 1.

### DETAILED DESCRIPTION

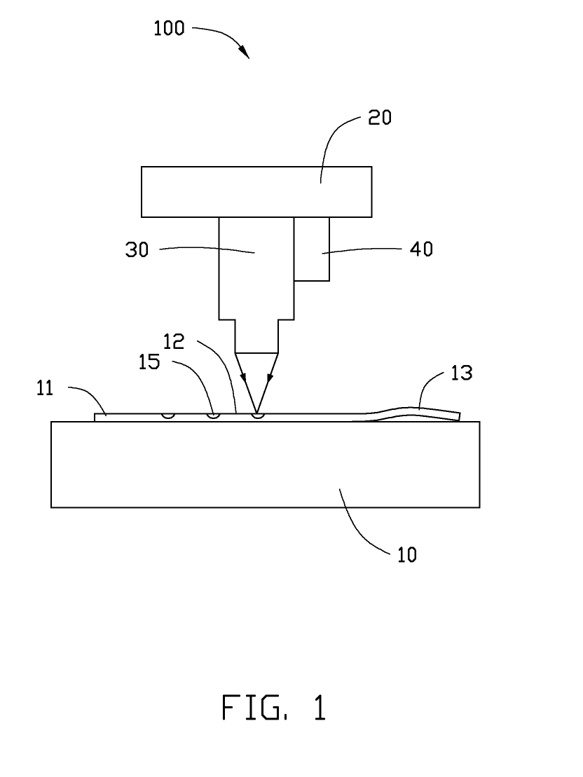

Referring to FIG. 1, a laser machining device 100 according to an exemplary embodiment is disclosed. The laser machining device 100 includes a stationary platform 10, a movable platform 20, a laser machining unit 30, and a distance measuring unit 40.

The stationary platform 10 is configured for carrying a workpiece 11. In the embodiment, the workpiece 11 is a steel plate. The workpiece 11 includes a machining surface 12 and further includes a warped portion 13.

The movable platform 20 is opposite to the stationary platform 10. The laser machining unit 30 and the distance measuring unit 40 are fixed on the movable platform 20. The laser machining unit 30 is configured for machining a number of micro-structures 15 in the machining surface 12 of the workpiece 11. In the embodiment, the micro-structures 15 are dot-shaped recesses. The movable platform 20 is configured for driving the laser machining unit 30 to move according to a predetermined route to machine the dot-shaped recesses 15 in the entire machining surface 12. The distance measuring unit 40 is configured for measuring a distance between the movable platform 20 and the machining surface 12 and adjusts the movable platform 20 to make sure a laser beam emitted by the laser machining unit 30 is focused on the machining surface 12 of the workpiece 11.

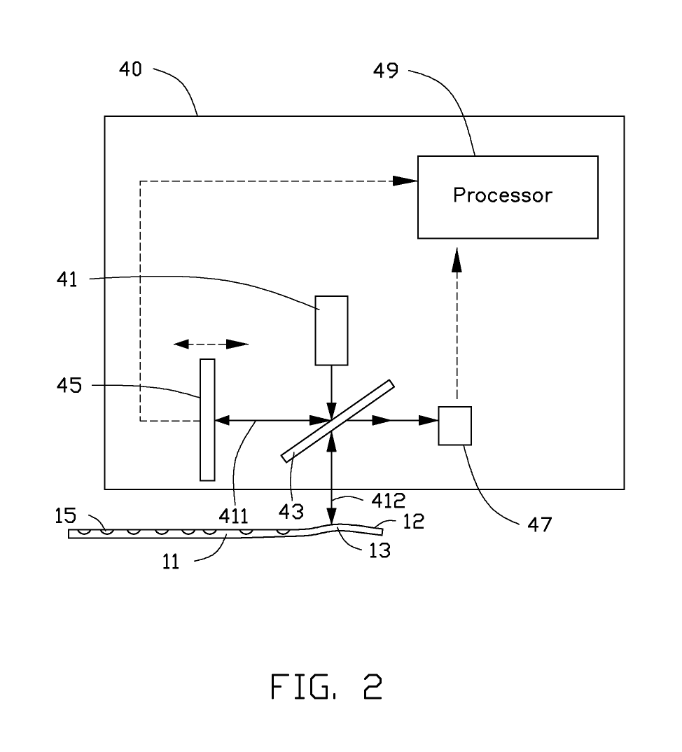

Referring to FIG. 2, in the embodiment, the distance measuring unit 40 is an interferometer. The distance measuring unit 40 includes a laser source 41, a splitter 43, a movable reflecting mirror 45, an optical detector 47, and a processor 49. The laser source 41 is configured for emitting a laser beam towards the splitter 43. The splitter 43 is a half transparent and half reflecting mirror. The splitter 43 splits the laser beam into a first laser beam 411 and a second laser beam 412. The first laser beam 411 is reflected by the splitter 43 and the movable reflecting mirror 45 in sequence, then is transmitted through the splitter 43 and reaches the optical detector 47. The second laser beam 412 is transmitted through the splitter 32, then is reflected by the workpiece 11 and the splitter 43 in sequence, and finally reaches the optical detector 47. The first laser beam 411 and the second laser beam 412 interfere with each other and form interference fringes at the optical detector 47. The optical detector 47 can be a charge-coupled device sensor or a complementary metal oxide semiconductor sensor. The optical detector 47 captures an image of the interference fringes and sends the image to the processor 49.

When working, first, the movable platform 20 is adjusted to make sure the laser beam emitted by the laser machining unit 30 is focused on the machining surface 12 of the workpiece 11. At the warped portion 13, the optical path of the second laser beam 412 is reduced and makes the interference fringes change. The processor 49 controls the movable reflecting mirror 45 to move along an optical path of the first laser beam 411 till the optical path of the first laser beam 411 is equal to that of the second laser beam 412 and the interference fringes recovers to its original pattern. The distance that the movable reflecting mirror 45 moves is the height of the warped portion 13 relative to other portions of the workpiece 11. The processor 49 adjusts the movable platform 20 according to the direction and the distance that the movable reflecting mirror 45 moves to make sure that the laser beam emitted by the laser machining unit 30 is focused on the machining surface 12 of the workpiece 11 when machining the warped portion 13.

In the embodiment, the laser machining unit 30 can be located at a number of machining positions corresponding to the micro-structures 15. The distance measuring unit 40 measures the distance between the movable platform 20 and the workpiece 11 at a next machining position next to a current machining position, thus, when the distance changes, the processor 49 does not move the movable platform 20 immediately, but moves the movable platform 20 when the laser machining unit 30 has been located at the next machining position.

In other embodiment, the distance measuring unit 40 can be other distance measuring equipment, such as a laser distance meter.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A laser machining device, comprising:
a stationary platform configured for carrying a workpiece;
a movable platform opposite to the stationary platform;
a laser machining unit; and
a distance measuring unit, both of the laser machining unit and the distance measuring unit fixed on the movable platform, the laser machining unit configured for machining micro-structures on the workpiece, the distance measuring unit configured for measuring a distance between the movable platform and the workpiece, and adjusting the movable platform to make sure that a laser beam emitted by the laser machining unit is focused on the workpiece.

2. The laser machining device of claim 1, wherein the workpiece is a steel plate.

3. The laser machining device of claim 1, wherein the micro-structures are dot-shaped recesses.

4. The laser machining device of claim 1, wherein the movable platform drives the laser machining unit to move according to a predetermined route to machine the micro-structures.

5. The laser machining device of claim 1, wherein the distance measuring unit is an interferometer.

6. The laser machining device of claim 5, wherein the interferometer comprises a laser source, a splitter, a movable reflecting mirror, an optical detector, and a processor, the laser source emits a laser beam towards the splitter, the splitter splits the laser beam into a first laser beam and a second laser beam, the first laser beam is reflected by the splitter and the movable reflecting mirror in sequence, then is transmitted through the splitter and reaches the optical detector, the second laser beam is transmitted through the splitter, then is reflected by the workpiece and the splitter in sequence, and finally reaches the optical detector, the first laser beam and the second laser beam interfere with each other and form interference fringes at the optical detector, and the optical detector captures an image of the interference fringes and sends the image to the processor.

7. The laser machining device of claim 6, wherein when the workpiece comprises a warped portion, an optical path of the second laser beam is reduced at the warped portion and makes the interference fringes change, the processor controls the movable reflecting mirror to move along an optical path of the first laser beam till the interference fringes recovers, the processor adjusts the movable platform according to a direction and a distance that the movable reflecting mirror moves to make sure that the laser beam emitted by the laser machining unit is focused on the workpiece.

8. The laser machining device of claim 6, wherein the splitter is a half transparent and half reflecting mirror.

9. The laser machining device of claim 1, wherein the distance measuring unit is a laser distance meter.
